(19) United States
(12) Patent Application Publication
(10) Pub. No.: US 2008/0032794 A1
(43) Pub. Date: Feb. 7, 2008

(54) Partitioned game console system

(75) Inventors: Frederick A. Ware, Los Altos Hills, CA (US); Ely K. Tsern, Los Altos, CA (US)

Correspondence Address: MORGAN LEWIS & BOCKIUS LLP/RAMBUS INC., 2 PALO ALTO SQUARE, 3000 EL CAMINO REAL, PALO ALTO, CA, 94306, US

(73) Assignee: Rambus, Inc.

(21) Appl. No.: 11/492,597

(22) Filed: Jul. 24, 2006

(51) Int. Cl. A63F 13/00

(52) U.S. Cl. 463/32

(57) ABSTRACT

The game console system includes a user interface module and a graphics processing module that are remotely situated from one another and solely coupled to one another via one or more communication links. The graphics processing module is positioned within a controlled environment chamber that thermally and acoustically isolates the user interface module from the graphics processing module. The user interface module includes a controller and a console coupled to the controller. The console also is configured to be coupled to a display.

### TECHNICAL FIELD

The present invention relates to a game console system, and more particularly to a game console system having a user interface module that is thermally and/or acoustically isolated from a graphics processing module.

### BACKGROUND

Today's game console systems provide users with realistic animation presented in real time. This animation makes use of graphics processing hardware where sophisticated 3D graphics are transformed into two-dimensional images that are displayed on users' displays. This graphics processing hardware utilizes components with large numbers of switching devices (hundreds of millions of transistors) operated at very high switching speeds (up to several billion clock cycles per second), resulting in a large processing rates (several trillion arithmetic operations per second). Some of these components generate significant amounts of heat and acoustic noise. This heat in turn degrades the overall performance and reliability of the game console systems. As such, game consoles are typically equipped with heat sinks and/or fans that direct ambient air flow across the components to cool the components by convection. However, as processing speeds increase, these cooling solutions have rapidly become inadequate. In addition, cooling air flow across the components is often impeded by other components within the game console; the cooling fans, themselves, generate heat and add significant noise to the game playing environment; etc. The heat sinks and/or fans also significantly impact the overall size of current game consoles.

To address safety concerns, such game consoles are typically restricted to predetermined upper surface temperature and noise limits. For example, the maximum allowable surface temperature of game console systems is typically 55° C. In addition, such game consoles are also typically powered via standard electrical wall outlets. These outlets typically provide 10 A at 120V, another limiting factor for powering the components and cooling the game consoles.

In light of the above, it would be highly desirable to provide a game system that provides the best possible performance while addressing the above drawbacks.

### BRIEF DESCRIPTION OF THE DRAWINGS

For a better understanding of the disclosure herein, reference should be made to the following detailed description taken in conjunction with the accompanying drawings, in which:

FIG. 1 is a block diagram of a game console system;

FIG. 2 is a block diagram of the controlled environment chamber and graphics processing module shown in FIG. 1;

FIG. 3 is a block diagram of the console shown in FIG. 1; and

FIG. 4 is a flow chart of a method of game-play using the embodiment shown in FIGS. 1-3.

Like reference numerals refer to the same or similar components throughout the several views of the drawings.

### DETAILED DESCRIPTION OF THE EMBODIMENTS

As described above, advances in game console systems are being hampered by a number of restrictions, including the maximum operating temperature of the semiconductor devices, maximum allowable noise level for a game console, the maximum allowable surface temperature of the game consol, and the maximum amount of power that a game console can draw from a standard electrical wall outlet. The following described embodiments of game console systems address these restrictions.

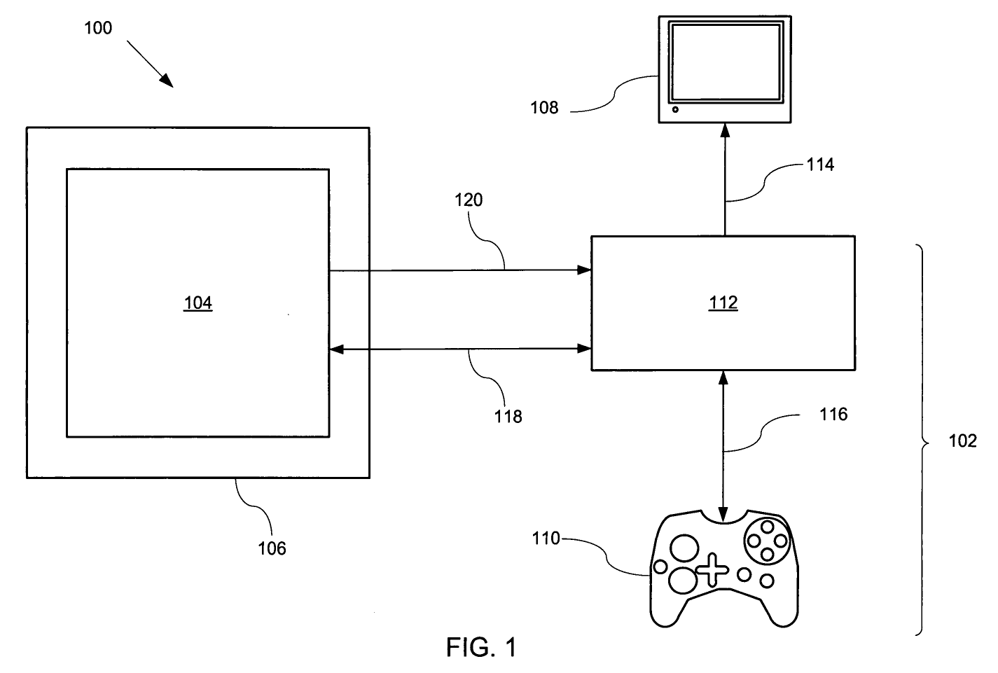

FIG. 1 is a block diagram of a game console system 100. The system 100 is divided into two distinct and remotely located subsystems that are connected to one another solely by electrical (wired), radio (wireless) and/or optical fiber communication links. The first subsystem includes a user interface module 102 configured to be located at the point of game-play, such as in a game room or living room. The second subsystem includes a graphics processing module 104. In some embodiments, the graphics processing module 104 is located in a controlled environment chamber 106.

The user interface module 102 is configured to electrically or optically couple to a display 108, such as a television or computer monitor. In some embodiments, the user interface module 102 includes a controller 110 and a console 112. In some embodiments, the user interface module 102 resembles a traditional game console system in that it contains a game console 112 configured to couple to the display 108 and a game controller 110. The console 112 connects to both the display 108 and the controller 110 via electrical, optical, and/or wireless links 114 and 116. However, the user interface module 102 differs from a traditional game console system in that the console 112 contains less computational hardware, as described below.

The graphics processing module 104 contains some, if not all, of the heat-generating computational hardware traditionally installed in game console systems, such as the transformer, the graphics processor, the graphics memory, the CPU, the memory, etc. In some embodiments, the graphics processing module 104 and the controlled environment chamber 106 are formed as a single device, while in other embodiments the graphics processing module 104 is simply housed within the controlled environment chamber 106.

During use, as shown, the graphics processing module 104 is disposed at a remote location to the user interface module 102. For example, the graphics processing module 104 may be located in a different room or even outside of the building in which the interface module 102 is located, or even in a separate building. In this way, during use, the graphics processing module 104 is thermally and/or acoustically isolated from the user interface module 102, and, therefore, can generate more heat and noise than traditionally tolerated, while maintaining a quiet and cool user environment. Raising the thermal limit by 10 to 30 times raises the performance of the system about 10 to 30 times.

In some embodiments, the graphics processing module 104 may also be coupled to a dedicated power supply circuit. For example, in some embodiments, the controlled environment chamber 106 includes a higher voltage source, such as an outlet that provides 50 A at 240V. The cost of this amount of power would be about $1/hour, affordable by a significant portion of the gaming community. This allows more power to be supplied to the graphics processor and the associated cooling mechanisms.

In some embodiments the graphics processing module 104 is disposed in the controlled environment chamber 106. The controlled environment chamber 106 may be a separate room or closet devoted to such purpose, an unenclosed space that is separate from the user environment, such as a section of another room, or of a garage or basement, or even a separate area of the room in which the user interface module 102 is located. Alternatively, the controlled environment chamber 106 may be an enclosed container disposed remotely from the user interface module 102, such as in another room or even outside the house or building in which the user interface module 102 is located.

In some embodiments, such an enclosed container may resemble a small refrigerator. In other embodiments, the controlled environment chamber 106 is not disposed remote from user interface module 102, but rather separated by a thermal and/or acoustic insulator, described below.

In most embodiments, the controlled environment chamber 106 is located remotely from the user interface module 102, e.g., in a separate room, a separate section of the same room, a separate building, etc. In this instance, “remote” refers to being situated in any location at which the user interface module 102 is thermally and acoustically insulated, within a reasonable tolerance, from the heat and noise generated by the controlled environment chamber 106. The term “remote” is not intended to be limiting, and a person of ordinary skill in the art will appreciate that many configurations are possible without departing from the scope of the invention.

The user interface module 102 is coupled to the graphics processing module 104 via one or more communication links. The communication links may include a first bidirectional communication link 118 between the graphics processing module 104 and the console 112 and/or the controller 110. This first communication link 118 may be any suitable wired or wireless communication link sufficient to communicate control signals from the controller 110 and/or the console 112 to the graphics processing module 104, and receive signals back, such as force feedback signals. The communication links may include a second unidirectional communication link 120 between the graphics processing module 104 and the console 112, which, in some embodiments, operates up to that needed for compressed high-definition video (about 0.6 Gb/s or faster). This communication link 120 may be any suitable wired or wireless communication link sufficient to communicate compressed video signals or frames from the graphics processing module 104 to the console 112. The communication links must also be able to support real-time game play (˜10 ms response time, or approximately the same as the video frame time) without any noticeable latency or lag time between controller input and generated video information. In an alternative embodiment, the link is sufficient to communicate uncompressed video signals or frames from the graphics processing module 104 to the console 112.

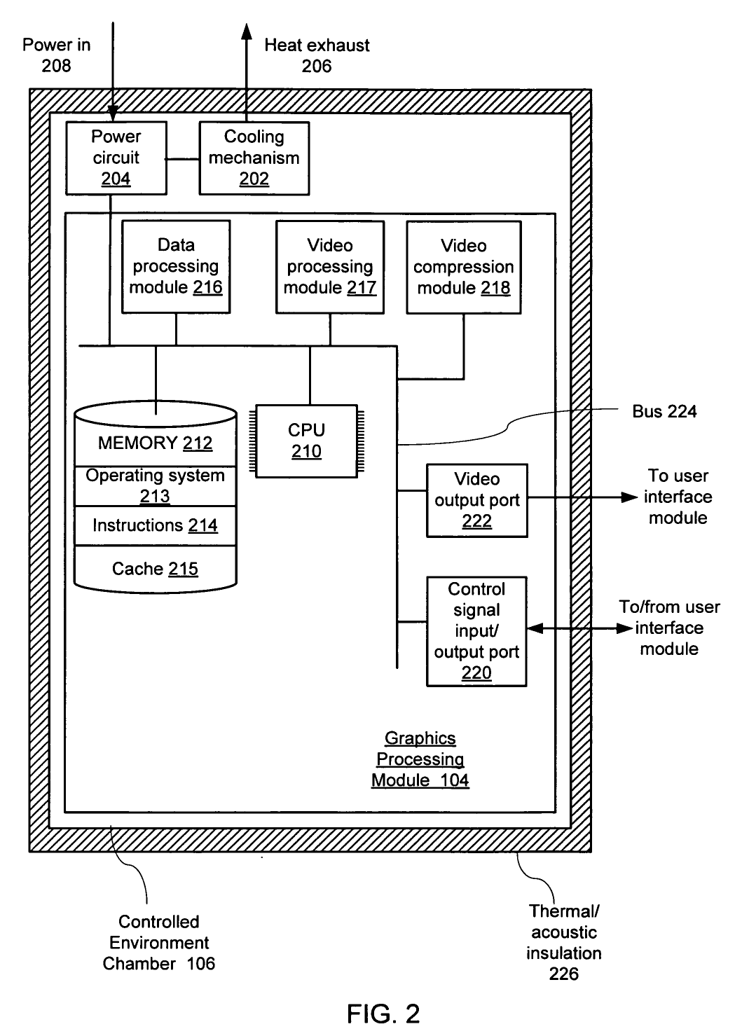

FIG. 2 is a block diagram of the controlled environment chamber 106 and graphics processing module 104 shown in FIG. 1. The controlled environment chamber 106 provides an environment in which the graphics processing module 104 can generate substantially more heat and noise, and in some embodiments also draw more power, than traditional game console systems. The controlled environment chamber 106 includes a cooling mechanism 202 to cool the computational hardware and expel heat generated by the graphics processing module 104 through an exhaust 206. The cooling mechanism may be any suitable mechanism for maintaining a preferred operating temperature in the controlled environment chamber 106. In some embodiments, the cooling mechanism 202 includes at least one fan. The fan may transfer heated air out of, or cooler exterior air into, the controlled environment chamber 106. In some embodiments, the at least one fan creates an air flow significantly larger than that typically provided in current game system consoles. Also in some embodiments, the components of the graphics processing module 104 are optimally situated to be cooled by the air flow generated by the at least one fan. The components may also be configured and/or oriented to maximize cooling by convection, such as by being spaced apart from one another and/or by having the components that generate the most heat being downstream from those that generate less.

In some embodiments, the at least one fan circulates pre-chilled air. The air may be chilled by a refrigeration or air conditioning cycle using a refrigerant such as sulfur dioxide, anhydrous ammonia, halomethanes such as R-11, R-12, R-22, and R-134a (Freon), propane, or any other refrigerant known in the art. The air may also be cooled by an evaporation cooler (swamp cooler), an absorptive chiller, or any other known refrigeration or air conditioning means. In an alternative embodiment, refrigeration is provided without the use of a fan. In an alternative embodiment, the air may be cooled by water, either drawn from the tap water system or circulated in a closed loop system.

The at least one fan may also introduce air from outside the controlled environment chamber 106 into the chamber. In embodiments in which the controlled environment chamber 106 is located within a home or building, the air may be obtained from outside through, for example, a duct. In embodiments in which the controlled environment chamber 106 is located outside of the home or building, the ambient exterior air may be used.

In some of the above described embodiments, the heated air is expelled through the heat exhaust 206 to the ambient environment, such as by hot air being expelled to the exterior of the house or building in which the controlled environment chamber is situated.

In other embodiments, the cooling mechanism 202 may utilize a liquid coolant, which may be used in conjunction with a refrigeration or air conditioning system as described above, or may directly cool the components without the use of a fan. The liquid coolant may be circulated in an open loop or closed loop system For example, the liquid coolant may even be tap water that once heated is expelled through the heat exhaust 206 to either a waste drain, a storage tank, to the house's or building's hot water heating system, to the house's or building's air heating (space heating) system, or to the house's or building's irrigation system for external planting. The processing components of module 104 operate at junction temperatures of about 100° C., meaning that the energy in the 100° C. liquid coolant is most efficiently utilized as a heat source for either hot water or space heating. Once the heat energy has been extracted, water coolant in an open loop system is available for normal usage, including irrigation. The cost of water for open loop cooling is well under $1 per hour (˜30 gallons/hour for 10 KW with 25° C. ambient), which can be mostly offset if the water is re-used for hot water or irrigation.

In some embodiments, especially useful in warmer climates, a coolant, such as water, may be circulated through a heat exchanger underground. The constant underground temperature allows for predictable and effective cooling even on hot days.

The controlled environment chamber 106 may also include a dedicated power supply circuit 204, such as a 240V A/C electrical outlet. The power supply circuit 204 uses the supplied power 208 to the power supply circuit 204 to power the graphics processing module 104.

The controlled environment chamber 106 may also include a housing made from a thermal and/or acoustic insulation material 226. This insulation material 226 may be any suitable material that is capable of reducing heat loss through the housing walls. For example, the insulation material 226 may be rock wool, slag wool, fiberglass, plastic fiber, cotton, polyester, hemp fiber, flax fiber, coco fiber, wool fiber, wood fiber, wood chips, sawdust, strawdust, polyolefin, cellulose, cork, grain, vermiculite, perlite, icynene, polyisocyanurate, phenolic (phenol-formaldehyde), polyurethane, polystyrene, polyisocyanurate, vacuum insulation, aerogels, or any other thermally insulating material known in the art. The kind and thickness of the insulation material 226 may be selected by a person of ordinary skill in the art based on the location and size of controlled environment chamber 106 and the kind of cooling mechanism 202.

The insulation material 226 may be used in conjunction with or instead of remoteness of the controlled environment chamber 106 from user interface module 102. For example, if the controlled environment chamber 106 is relatively far from user interface module 102, such as in a garage or external building, a small amount of insulation material 226 may be required, whereas if controlled environment chamber 106 is relatively near user interface module 102, such as in the same room, a larger amount of insulation material 226 may be required.

This insulation material 226 may also be any suitable material that is capable reducing sound propagation. For example, the controlled environment chamber 106 may be acoustically isolated with a sound baffle or with acoustic insulation that contains sound deadening materials, such as open-celled foam, or any other material known in the art to reduce or absorb noise. The kind and thickness of insulation material 226 may be selected by a person of ordinary skill in the art based on the location and size of controlled environment chamber 106, the noise produced by cooling mechanism 202, if any, being used, and the teachings herein. The acoustic insulation may be used in conjunction with or instead of remoteness of controlled environment chamber 106 from user interface module 102, as described above.

In addition, in some embodiments, controlled environment chamber 106 may be acoustically isolated with active noise control, as may be implemented by a person of ordinary skill in the art based on the teachings herein. Active noise control may be used in conjunction with or instead of remoteness, a sound baffle, and/or acoustic insulation.

In some embodiments, the acoustic insulation or isolation is such that noise levels at the user interface module 102 location are less than about 30 dB at 1 meter.

The graphics processing module 104 includes a plurality of components, such as at least one central processing unit (CPU) 210, a memory 212, a data processing module 216, a video processing module 217, a video compression module 218, a video output port 222, a control signal input (or input/output) port 220, and at least one bus 224 that connects the aforementioned components. Different embodiments may include some or all of these components.

The CPU 210 may comprise programmable or non-programmable circuits, such as ASICs or microcontrollers. This circuitry typically does not include non-volatile memory, but a separate non-volatile memory device may be used to retain programmed memory 212 functionality, event logs, and/or data, even after a period of power that is insufficient for continued operation. The video output port 222 is used to send compressed video data (such as frames) to the user interface module 102 (FIG. 1). In some embodiments, the video output port 222 includes an optoelectronic transmitter configured to transmit optical signals along an optical fiber to the user interface module 102 (FIG. 1). The control signal port 220 is configured to receive control signals generated by the controller 110 (FIG. 1). In some embodiments, the control signal port 220 is also configured to send signals to the user interface module 102 (FIG. 1), such as force feedback signals to the controller 110 (FIG. 1).

The memory 212 may comprise various procedures including, for example, an operating system 213, other instructions 214 for operating the plurality of components, and a cache 215 for temporarily storing data. The operating system 213 includes instructions for communicating, processing, accessing, storing, or searching data. An example of a suitable operating system is an embedded LINUX system. In some embodiments, the functionality of the data processing module 216, video processing module 217, and video compression module 218 are undertaken in the software instructions 214 or in a combination of software and hardware.

The data processing module 216, video processing module 217, and video compression module 218 handle various processes for running the gaming system. The data processing module 216 processes data, such as calculations for game play, etc. For example, the data processing module 216 maintains and updates the positions of all objects in a 3D space. This includes using information received from the controller device 110 (and force feedback output), physics processing of the objects in the space, the AI (artificial intelligence) processing of computer-controlled entities, and the information from other human-controlled entities (either on-line or connected locally).

The video processing module 217 processes game graphics and may include graphics pipelining procedures, etc. For example, the video processing module 217 processes accepts/rejects objects, decomposes 3D objects into surface polygons/vertices, transforms polygons/vertices according to the viewing angle/position, accepts/rejects polygons/vertices, clips polygons/vertices according to the viewing frustum, undertkes lighting/shading/illumination calculations for polygons/vertices, undertakes perspective transformation of polygons/vertices, renders polygons into 2D pixels, maps textures onto 2D pixels, and merges pixels into 2D viewing frame (including blending of sub-pixels and Z-compare for hidden surface removal). In other words, in some embodiments, the video processing module 217 generates game objects in a three-dimensional (3D) graphical space and transforms them into two dimensional (2D) video frames.

The video compression module 218 is used to compress the 2D video frames into compressed video frames for transmission to the user interface module 102. In other words, video compression module 218 sends the next finished 2D frame to the display device when the device is ready (this is a fixed rate of approximately one frame every 10 ms or so). The 2D image compression may also be undertaken by the video compression module 218. Suitable compression schemes include lossless and lossy methods including, but not limited to, run-length encoding, variable-length encoding, entropy coding, motion prediction of pixel blocks, interpolation of pixels or pixel blocks between frames, transformation of pixel intensity into the spatial frequency domain, and quantization of pixel and spatial frequency values. The compression/decompression scheme chosen may utilize methods that limit latency, so that real-time control is not impacted.

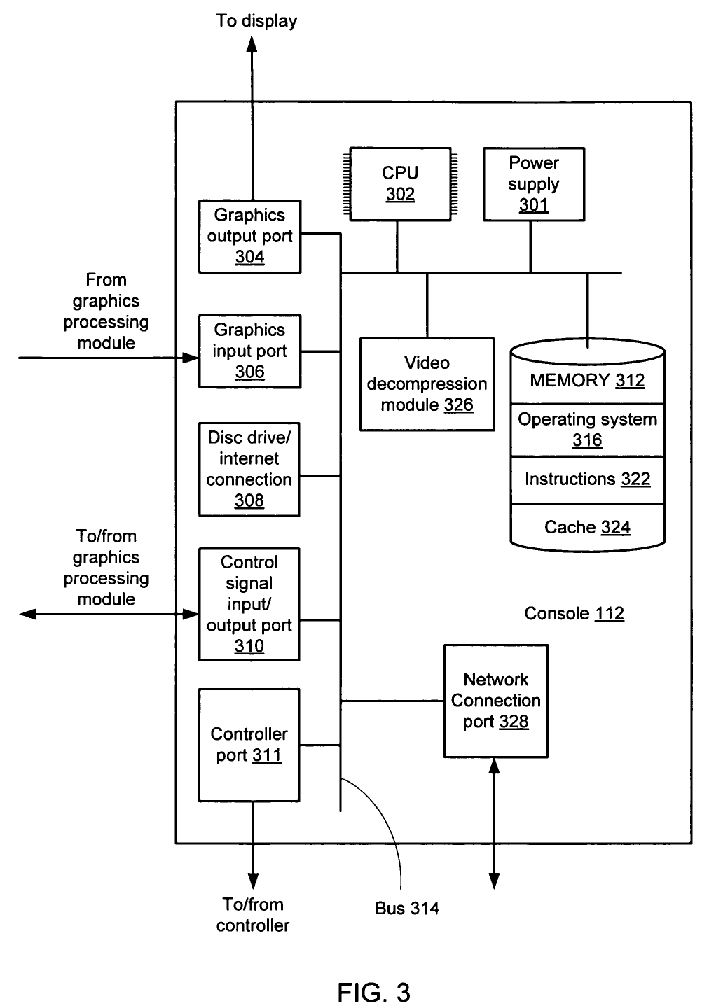

FIG. 3 is a block diagram of the console 112 shown in FIG. 1. The console 112 includes a plurality of components, such as a power supply 301, at least one central processing unit (CPU) 302, a memory 312, a video decompression module 326, a video output port 304, a video input port 306, an optional DVD drive and/or internet connection 308 for loading a game, a control signal output (or input/output) port 310, a controller port 311, a network connection port 328, and at least one bus 314 that connects the aforementioned components. Different embodiments may include some or all of these components. The memory may include a hard disc drive. In some embodiments, the DVD drive and/or hard drive may be located in a device remote from the console 112.

The CPU 302 may comprise programmable or non-programmable circuits, such as ASICs or microcontrollers. This circuitry typically does not include non-volatile memory, but a separate non-volatile memory device may be used to retain programmed memory 312 functionality, event logs, and/or data, even after a period of power that is insufficient for continued operation. The video output port 304 is used to send video to the display 108 (FIG. 1) at about 6.4 Gb/s or faster. The video input port 306 receives compressed video signals from the video output port 222 in 104 (FIGS. 1 and 2). The control signal port 310 is configured to transmit control signals generated by the controller 110 (FIG. 1) to the graphics processing module 104 (FIGS. 1 and 2). In some embodiments, the control signal port 310 is also configured to receive signals from the graphics processing module 104 (FIGS. 1 and 2), such as force feedback signals or audio signals for the controller 110 (FIG. 1). The control signal port 310 is also used to load the memory in the graphics processing module 104 (FIG. 1) with the game from the DVD drive or the internet at about 50 Mb/s or faster. The controller port 311 is used to communicate with the controller 110 (FIG. 1) at about 1 Mb/s or faster. The optional network communication port 328 is used to communicate with an external network, such as the Internet.

The memory 312 may include various procedures including, for example, an operating system 316, instructions 322, and a cache 324 for temporarily storing data. In some embodiments, the cache forms part of the CPU. The operating system 316 includes instructions for communicating, processing, accessing, storing, or searching data. An example of a suitable operating system is an embedded LINUX system. The instructions 322 control the console.

The video decompression module 326 is used to decompress the video received from the graphics processing module 104. In some embodiments, the video decompression process is handled by dedicated hardware using dedicated signal paths. In other embodiments, the decompression module 326 is embodied in software and not hardware, while in yet other embodiments, the decompression module 326 are embodied in a combination of hardware and/or software.

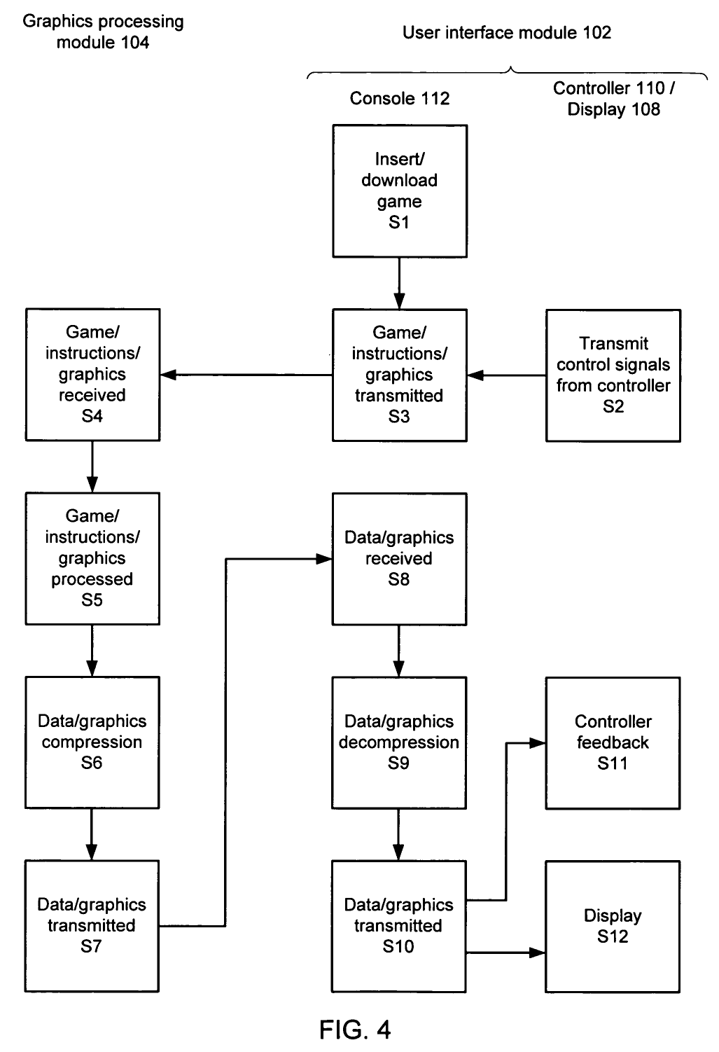

FIG. 4 is a flow chart of a method of game-play using the embodiment shown in FIGS. 1-3. According to an exemplary embodiment, a user inputs game software through, for example, the DVD drive, hard drive, or connection to the internet at step S1. The game data is transmitted to the graphics processing module 104 (FIG. 1) by the user interface module 102 (FIG. 1) at step S3. The game data are received by the graphics processing module 104 (FIG. 1) at step S4. The game data are then processed by the data processing module 216 (FIG. 2) and the video processing module 217 (FIG. 2) at step S5. This may include graphics pipelining to generate 2D video frames from objects in a 3D graphics space.

The video frames are then compressed by the video compression module 218 (FIG. 2) using any suitable data or video compression schemes at step S6. The compressed video frames are then transmitted from the graphics processing module 104 (FIG. 1) to the console 112 (FIG. 1) at step S7. The video frames are received by the graphics processing module 104 at step S8, and the decompression module 322 (FIG. 3) decompress the video frames at step S9. The decompressed video frames may or may not be converted to analog and then sent to the display 108 (FIG. 1) at step S10. The display then receives the startup screen video and/or graphics and displays them to the user at step S12.

During game play the user then selects or inputs control signals via the controller 110 (FIG. 1). These control signals are then transmitted to the console at step S2, which receives them, at step S3, and transmits them to the control signal port 220 (FIG. 2) of the graphics processing module 104 (FIG. 1) at step S3. Alternatively, the controller may transmit the control signals directly to the graphics processing module 104 (FIG. 1).

The control signals are received by the graphics processing module 104, at step S4, and the control signals processed at step S5. This may include generating new video scenes using graphics pipelining, or the like. The data and/or graphics (including video) are then compressed by the compression module 216 (FIG. 2) using any suitable data or video compression schemes at step S6. The compressed data and/or graphics are then transmitted from the graphics processing module 104 (FIG. 1) to the console 112 (FIG. 1) at step S7. The data and/or graphics are received by the graphics processing module 104 at step S8, and the decompression module 322 (FIG. 3) decompress the graphics and/or data receives at step S9. The decompressed graphics may or may not be converted to analog and then sent to the display 108 (FIG. 1) at step S10. The display then receives the new video scenes and displays them to the user at step S12.

At the same time, any control signals are sent back to the console or controller, at step S7, such as force feed back to the controller (such as at about 1 Mb/s or faster). The controller or console then receives the control signals and evokes them at step S111, such as by vibrating the controller for force feedback.

In an alternative embodiment, the console 112 supports two modes of operating. The first mode is as described above, where the video is generated in the graphics processing module. In the second mode, the video is generated in the console without the assistance of the graphics processing module. In the second mode, the quality of the graphics may be degraded because of the reduced computation capability of the console.

The above described embodiments operate in real-time with little or no latency, i.e., game-play is fluid and does not have any observable latency between inputting a control signal and being presented with an updated game graphic or video. Safety concerns are addressed as the heat and noise generation is remotely located from the point of game-play. In addition, more powerful processors, cooling mechanisms, etc. may be employed as a higher power circuitry is provided at the graphics processing module that is remote from the user.

While the foregoing description and drawings represent the preferred embodiments of the present invention, it will be understood that various additions, modifications and substitutions may be made therein without departing from the spirit and scope of the present invention as defined in the accompanying claims. In particular, it will be clear to those skilled in the art that the present invention may be embodied in other specific forms, structures, arrangements, proportions, and with other elements, materials, and components, without departing from the spirit or essential characteristics thereof. For example, it will be appreciated that graphics processing module 104 (FIG. 1) need not be limited to processing graphics only. Also, any hardware and/or software used in the game system may be housed in the controlled environment chamber 106 (FIG. 1) instead of in the console 112. For example, only the controller 110 (FIG. 1) and the display 108 (FIG. 1) need be located at the point of game-play. Further, while a game system has been disclosed for exemplary purposes, it will be appreciated that the present invention can be used for any computational system, particularly those with heat-producing elements. The presently disclosed embodiments are therefore to be considered in all respects as illustrative and not restrictive, the scope of the invention being indicated by the appended claims, and not limited to the foregoing description.

What is claimed is:

1. A game console system comprising:
a first computing device configured to: generate game objects in a three-dimensional (3D) graphical space, transform the game object into two dimensional (2D) video frames, compresses the 2D video frames into compressed video frames; and transmit the compressed video frames to a second computing device;
a second computing device configured to: receive the compressed video frames, decompresses the compressed video frames to decompressed video frames, and transmit the decompressed video frames to a display device, wherein the first and second computing devices are configured to operate in separate thermal environments.

2. The game console system of claim 1, wherein during use the first and second computing devices are separated from one another by a predetermined distance.

3. The game console system of claim 1, wherein the predetermined distance is between 30 to 100 meters.

4. The game console system of claim 1, wherein the first computing device comprises a cooling mechanism configured to cool the first computing device.

5. The game console system of claim 3, wherein the cooling mechanism forms part of a housing of the first computing device.

6. The game console system of claim 3, wherein the cooling mechanism comprises at least one fan.

7. The game console system of claim 3, wherein the cooling mechanism comprises a refrigeration unit.

8. The game console system of claim 3, wherein the cooling mechanism comprises a heat pump or a heat exchanger for transferring heat to an environment exterior to the first computing device.

9. The game console system of claim 8, wherein the environment comprises a household hot water system or a heating system.

10. The game console system of claim 3, wherein the cooling mechanism is configured to dissipate at least 10 KW of heat per hour.

11. The game console system of claim 1, wherein the first computing device further comprises a power supply circuit configured to provide 240V to the first computing device.

12. The game console system of claim 1, wherein first and second commuting devices are coupled to one another via a unidirectional communication link configured to transport the compressed video frames from the first computing device to the second computing device.

13. The game console system of claim 12, wherein the unidirectional communication link is configured to transport the compressed video frames at 0.6 Gb/s or faster.

14. The game console system of claim 1, wherein the second computing device is configured to receive instructions from a controller.

15. The game console system of claim 14, further comprising a communications link between the second computing device and the first computing device for transmitting the instructions from the controller to the first computing device at 1 Mb/s or faster.

16. The game console system of claim 14, further comprising a communications link between the second computing device and the first computing device for transmitting the instructions from the controller to the first computing device at 1 Mb/s or faster, and transmitting feedback signals to the controller at 1 Mb/s or faster.

17. The game console system of claim 1, further comprising a communications link between the second computing device and the first computing device for loading game data to the first computing device at 50 MB/s or faster.

18. The game console system of claim 1, wherein during use the first and second computing devices are substantially acoustically isolated from one another.

19. The game console system of claim 1, wherein during use the first computing device produces 30 decibels or less of noise at the second computing device.

20. The game console system of claim 1, wherein during use the second computing device is configured to transmit uncompressed video to the display at 6.4 Gb/s or faster.

21. The game console system of claim 1, wherein communication links between the first and second computing devices are configured to support real-time game play at a response time of 10 ms or less.

22. The game console system of claim 1, wherein the compression and decompression is performed using a compression scheme selected from a group consisting of: a lossless method, a lossy method, run-length encoding, variable-length encoding, entropy coding, motion prediction of pixel blocks, interpolation of pixels or pixel blocks between frames, transformation of pixel intensity into the spatial frequency domain, quantization of pixel and spatial frequency values, and any combination of the aforementioned.

23. A game console system comprising:
a first computing device configured to operate in a first thermal environment, the first computing device comprising:
a data processing module configured to generate a three-dimensional (3D) game objects;
a video processing module configured to transform the game objects into two dimensional (2D) video frames; and
a video compression module configured to compress the 2D video frames into compressed video frames for transmission to a second computing device;
a second computing device configured to operate in a second thermal environment separate from the first thermal environment, the second computing device comprising a video decompression module configured to decompress the compressed video frames to decompressed video frames.

24. The game console system of claim 23, wherein during use the first and second computing devices are separated from one another by a predetermined distance of between 30 to 100 meters.

25. The game console system of claim 23, wherein the first computing device comprises a cooling mechanism configured to cool the first computing device, wherein said cooling device is selected from a group consisting of: at least one fan, a refrigeration unit, a heat pump, a heat exchanger, and any combination of the aforementioned.

26. The game console system of claim 23, wherein the cooling mechanism is configured to dissipate at least 10 KW of heat per hour.

27. The game console system of claim 23, wherein the first computing device further comprises a power supply circuit configured to provide 240V to the first computing device.

28. The game console system of claim 23, wherein first and second commuting devices are coupled to one another via a unidirectional communication link configured to transport the compressed video frames from the first computing device to the second computing device at 0.6 Gb/s or faster.

29. The game console system of claim 23, wherein the second computing device is configured to receive instructions from a controller.

30. The game console system of claim 29, further comprising a communications link between the second computing device and the first computing device for transmitting data between the controller and the first computing device at 1 Mb/s or faster.

31. The game console system of claim 23, further comprising a communications link between the second computing device and the first computing device for loading game data to the first computing device at 50 MB/s or faster.

32. The game console system of claim 23, wherein during use the first and second computing devices are substantially acoustically isolated from one another, such that the first computing device produces 30 decibels or less of noise at the second computing device.

33. The game console system of claim 23, wherein during use the second computing device is configured to transmit uncompressed video to the display at 6.4 Gb/s or faster.

34. The game console system of claim 23, wherein communication links between the first and second computing devices are configured to support real-time game play at a response time of 10 ms or less.

35. A game console system comprising:
a first means for computing configured to operate in a first thermal environment, the first means for computing comprising:
means for generating game objects in a three-dimensional (3D) graphical space;
means for transforming the game objects into two dimensional (2D) video frames; and
means for compressing the 2D video frames into compressed video frames for transmission to a second computing device;
a second means for computing configured to operate in a second thermal environment separate from the first thermal environment, the second means for computing comprising:
means for decompressing the compressed video frames to decompressed video frames; and
means for transmitting the decompressed video frames to a means for displaying.

36. The game console system of claim 35, wherein during use the first and second means for computing are separated from one another by a predetermined distance of between 30 to 100 meters.

37. The game console system of claim 35, wherein the first means for computing comprises a means for cooling the first means for computing, wherein said means for cooling is selected from a group consisting of: at least one fan, a refrigeration unit, a heat pump, a heat exchanger, and any combination of the aforementioned.

38. The game console system of claim 35, wherein first and second means for computing are coupled to one another via a means for communicating the compressed video frames from the first means for computing to the second means for computing at 0.6 Gb/s or faster.

39. The game console system of claim 35, wherein the second means for computing is configured to receive instructions from a means for controlling.

40. The game console system of claim 39, further comprising a communications link between the second means for computing and the first means for computing for transmitting data between the means for controlling and the first means for computing at 1 Mb/s or faster.

41. The game console system of claim 35, further comprising a means for communicating communications between the second means for computing and the first means for computing for loading game data to the first means for computing at 50 MB/s or faster.

42. The game console system of claim 35, wherein during use the first and second means for computing are substantially acoustically isolated from one another, such that the first means for computing produces 30 decibels or less of noise at the second means for computing.

43. The game console system of claim 35, wherein during use the second means for computing is configured to transmit uncompressed video to means for displaying at 6.4 Gb/s or faster.

44. The game console system of claim 35, wherein means for communicating between the first and second means for computing are configured to support real-time game play at a response time of 10 ms or less.

45. A gaming method, comprising:
at a first computing device:
generating game objects in a three-dimensional (3D) graphical space;
transforming the game object into two dimensional (2D) video frames;
compressing the 2D video frames into compressed video frames; and
transmitting the compressed video frames to a second computing device;
at a second computing device:
receiving the compressed video frames from the first computing device;
decompressing the compressed video frames to decompressed video frames; and
transmitting the decompressed video frames to a display device, wherein the first and second computing devices are configured to operate in separate thermal environments.
